(19) United States
(12) Patent Application Publication
(10) Pub. No.: US 2012/0002800 A1
(43) Pub. Date: Jan. 5, 2012

(54) Subscriber Line Interface Circuit with DC-DC Converter Current Protection

(76) Inventor: Sean A. Lofthouse, Austin, TX (US)

(21) Appl. No.: 12/828,226

(22) Filed: Jun. 30, 2010

(51) Int. Cl. H04M 1/78

(52) U.S. Cl. 379/412

(57) ABSTRACT

A method of controlling a switching regulator includes setting a current limit (ILIM) to a first value, I_{LIM1}. An error voltage (V_{ERR}) is computed as a difference between an output voltage VOUT of the switching regulator and a reference voltage VREF of the switching regulator. The switching regulator current limit is set to a second value I_{LIM2}, if the error voltage is greater than a first threshold voltage, V_{TH1}. The switching regulator current limit is set to the first value, if the error voltage does not exceed a second threshold value, V_{TH2}.

### BACKGROUND

Subscriber line interface circuits are typically found in the central office exchange of a telecommunications network. A subscriber line interface circuit (SLIC) provides a communications interface between the digital switching network of a central office and an analog subscriber line. The analog subscriber line connects to a subscriber station or telephone instrument at a location remote from the central office exchange.

The analog subscriber line and subscriber equipment form a subscriber loop. The interface requirements of a SLIC result in the need to provide relatively high voltages and currents for control signaling with respect to the subscriber equipment on the subscriber loop. Voiceband communications are low voltage analog signals on the subscriber loop. Thus the SLIC must detect and transform low voltage analog signals into digital data for transmitting communications received from the subscriber equipment to the digital network. For bi-directional communication, the SLIC must also transform digital data received from the digital network into low voltage analog signals for transmission on the subscriber loop to the subscriber equipment.

A subscriber line interface circuit requires different power supply levels depending upon operational state. One supply level is required when the subscriber equipment is “on hook” and another supply level is required when the subscriber equipment is “off hook”. Yet another supply level is required for “ringing”.

The SLIC must be provided with a negative voltage supply sufficient to accommodate the most negative loop voltage while maintaining the SLIC internal circuitry in their normal region of operation. In order to ensure sufficient supply levels, a power supply providing a constant or fixed supply level sufficient to meet or exceed the requirements of all of these states may be provided. However, such solutions invariable result in wasted power for at least some operational states.

More recent architectures utilize switching circuitry to generate the appropriate supply level from a fixed supply level. Unlike the fixed supply level solution, however, the switching circuitry is susceptible to instabilities due to start-up, short circuit, or other overload events. Although heavier duty components can be utilized to handle the power consumed by the switching circuitry during these events, such components incur greater costs.

### SUMMARY

A method of controlling a switching regulator includes setting a current limit (ILIM) to a first value, I_{LIM1}. An error voltage (V_{ERR}) is computed as a difference between an output voltage VOUT of the switching regulator and a reference voltage VREF of the switching regulator. The switching regulator current limit is set to a second value I_{LIM2}, if the error voltage is greater than a first threshold voltage, V_{TH1}. The switching regulator current limit is set to the first value, if the error voltage does not exceed a second threshold value, V_{TH2}.

Other features and advantages of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates one embodiment of a subscriber line interface circuit.

FIG. 2 illustrates one embodiment of a power supply system for a SLIC.

FIG. 3 illustrates one embodiment of a switching regulator.

FIG. 4 illustrates an alternative embodiment of a switching regulator.

FIG. 5 illustrates one embodiment of a switching regulator control apparatus.

FIG. 6 illustrates one embodiment of a method of switching regulator control.

FIG. 7 illustrates one embodiment of a switching regulator overcurrent protection apparatus.

### DETAILED DESCRIPTION

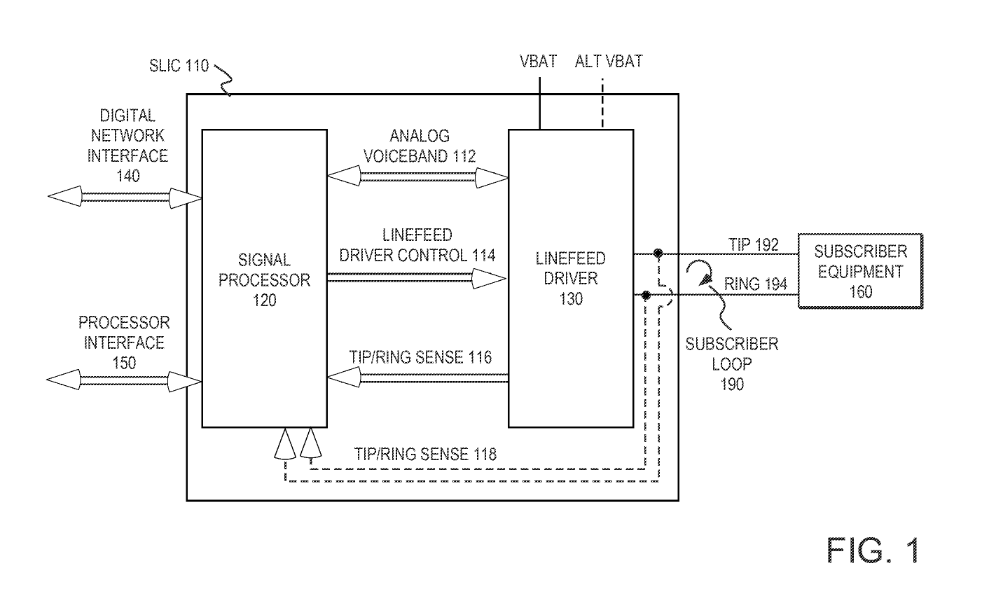

FIG. 1 illustrates one embodiment of a subscriber line interface circuit 110 associated with plain old telephone services (POTS) telephone lines. The subscriber line interface circuit (SLIC) provides an interface between a digital switching network of a local telephone company central exchange and a subscriber line comprising a tip 192 and a ring 194 line. A subscriber loop 190 is formed when the subscriber line is coupled to subscriber equipment 160 such as a telephone.

The subscriber loop 190 communicates analog data signals (e.g., voiceband communications) as well as subscriber loop “handshaking” or control signals. The subscriber loop state is often specified in terms of the tip 192 and ring 194 portions of the subscriber loop.

The SLIC is typically expected to perform a number of functions often collectively referred to as the BORSCHT requirements. BORSCHT is an acronym for “battery feed,” “overvoltage protection,” “ringing,” “supervision,” “codec,” “hybrid,” and “test.” The term “linefeed” will be used interchangeably with “battery feed”. Modern SLICs may have battery backup, but the supply to the subscriber line is typically not actually provided by a battery despite the retention of the term “battery” to describe the supply (e.g., VBAT).

The ringing function, for example, enables the SLIC to signal the subscriber equipment 160. In one embodiment, subscriber equipment 160 is a telephone. Thus, the ringing function enables the SLIC to ring the telephone.

In the illustrated embodiment, the BORSCHT functions are distributed between a signal processor 120 and a linefeed driver 130. The signal processor and linefeed driver typically reside on a linecard (110) to facilitate installation, maintenance, and repair at a central exchange. Signal processor 120 is responsible for at least the ringing control, supervision, codec, and hybrid functions. Signal processor 120 controls and interprets the large signal subscriber loop control signals as well as handling the small signal analog voiceband data and the digital voiceband data.

In one embodiment, signal processor 120 is an integrated circuit. The integrated circuit includes sense inputs for both a sensed tip and a sensed ring signal of the subscriber loop. The integrated circuit generates subscriber loop linefeed driver control signal in response to the sensed signals. The signal processor has relatively low power requirements and can be implemented in a low voltage integrated circuit operating in the range of approximately 5 volts or less. In one embodiment, the signal processor is fabricated as a complementary metal oxide semiconductor (CMOS) integrated circuit.

Signal processor 120 receives subscriber loop state information from linefeed driver 130 as indicated by tip/ring sense 116. The signal processor may alternatively directly sense the tip and ring as indicated by tip/ring sense 118. This information is used to generate linefeed driver control 114 signals for linefeed driver 130. Analog voiceband 112 data is bi-directionally communicated between linefeed driver 130 and signal processor 120. In an alternative embodiment, analog voiceband signals are communicated downstream to the subscriber equipment via the linefeed driver but upstream analog voiceband signals are extracted from the tip/ring sense 118.

SLIC 110 includes a digital network interface 140 for communicating digitized voiceband data to the digital switching network of the public switched telephone network (PSTN). The SLIC may also include a processor interface 150 to enable programmatic control of the signal processor 120. The processor interface effectively enables programmatic or dynamic control of battery control, battery feed state control, voiceband data amplification and level shifting, longitudinal balance, ringing currents, and other subscriber loop control parameters as well as setting thresholds including ring trip detection and off-hook detection threshold.

Linefeed driver 130 maintains responsibility for battery feed to tip 192 and ring 194. The battery feed and supervision circuitry typically operate in the range of 40-75 volts. The battery feed is negative with respect to ground, however. Moreover, although there may be some crossover, the maximum and minimum voltages utilized in the operation of the battery feed and supervision circuitry (−48 or less to 0 volts) tend to define a range that is substantially distinct from the operational range of the signal processor (e.g., 0-5 volts). In some implementations the ringing function is handled by the same circuitry as the battery feed and supervision circuitry. In other implementations, the ringing function is performed by separate higher voltage ringing circuitry (75-150 Vᵣₘₛ).

Linefeed driver 130 modifies the large signal tip and ring operating conditions in response to linefeed driver control 114 provided by signal processor 120. This arrangement enables the signal processor to perform processing as needed to handle the majority of the BORSCHT functions. For example, the supervisory functions of ring trip, ground key, and off-hook detection can be determined by signal processor 120 based on operating parameters provided by tip/ring sense 116.

The linefeed driver receives a linefeed supply VBAT for driving the subscriber line for SLIC “on-hook” and “off-hook” operational states. An alternate linefeed supply (ALT VBAT) may be provided to handle the higher voltage levels (75-150 Vrms) associated with ringing.

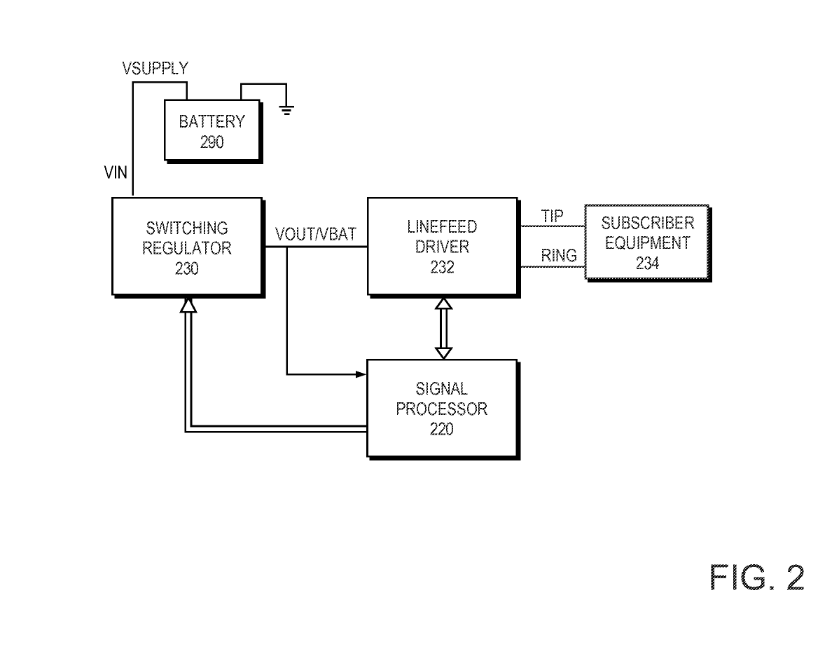

A variable power supply can be used to provide a VBAT level suitable for the needs of the SLIC. FIG. 2 illustrates one embodiment of a power supply system for a SLIC.

The variable power supply system includes a switching regulator 230. In one embodiment, switching regulator 230 forms a DC-DC converter power supply. The power supply system relies upon a switching regulator or switchers as needed to provide the appropriate VBAT from VIN. In order to avoid confusion with the term “VBAT”, the term VSUPPLY is used to describe the supply from an actual battery 290. The term “VBAT” describes the supply provided to the linefeed driver irrespective of whether VBAT is actually provided by any battery.

In the illustrated embodiment VSUPPLY is provided by one or more batteries such as battery 290. A switching regulator receives VSUPPLY as its VIN and provides a VBAT. In one embodiment, the switching regulator passes VSUPPLY as-is when is idle (i.e., VBAT≈VIN≈VSUPPLY). When commutated, however, the switching regulator boosts the VSUPPLY such that

$$\frac{VOUT}{VIN} > 1.$$

In the illustrated embodiment, the switching regulator is controlled to adjust VBAT as needed for the particular operational state of the subscriber equipment 234 driven by the linefeed driver 232. Control of the switching regulator is provided by the signal processor 220.

The basic components of a switching regulator include a diode, a switch, and an inductor. Feedback and control circuitry are provided to regulate the transfer of energy from input to output and to maintain the desired VBAT supply levels.

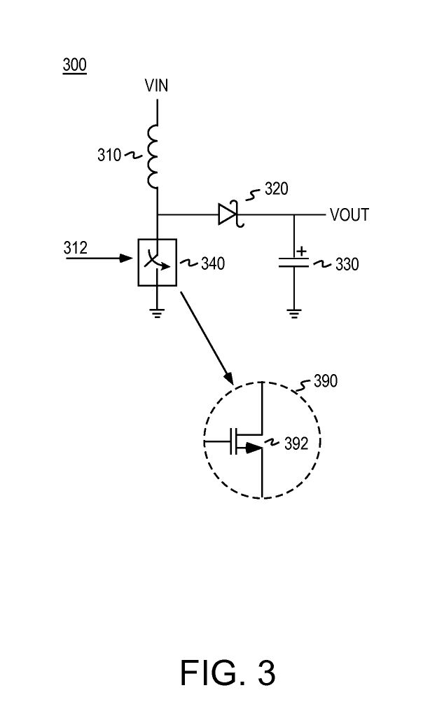

One embodiment of a switching regulator is illustrated in FIG. 3. The switching regulator includes an inductor 310, a diode 320, a capacitor 330, and a switching element 340. As illustrated in callout 390, the switching element is a MOSFET 392 in one embodiment. The switching signal 312 is applied to the gate of the MOSFET in order to turn it on and off.

In the “idle” state, the switching element is not commutated and the switching element does not provide a conducting path to ground (i.e., the switching element is left in an “open circuit” state). As previously noted VBAT≈VSUPPLY in the typical idle state.

When commutated, the switching regulator from the inductor 310 to capacitor 330. The

$$\frac{VOUT}{VIN}$$

ratio is determined by the duty cycle and frequency of the switching control 312. In one embodiment, switching control 312 is provided by the signal processor of the SLIC.

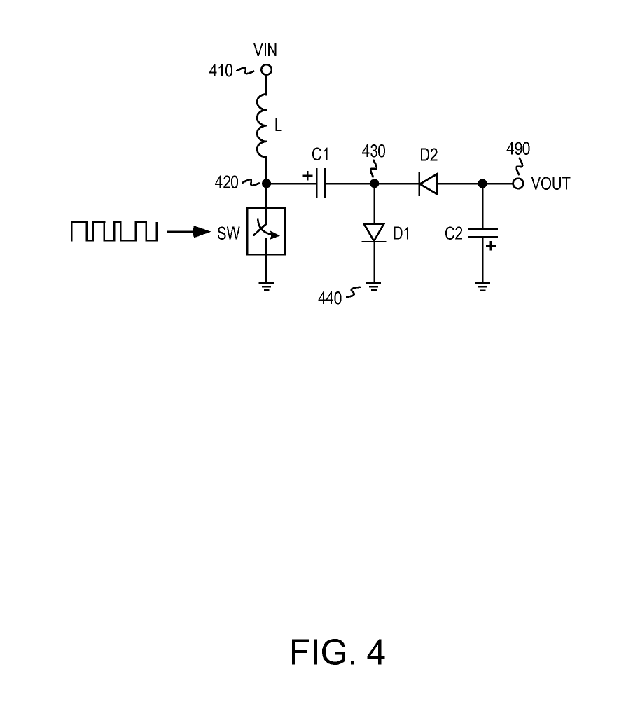

FIG. 4 illustrates another embodiment of a switching regulator. This is an inverting topology. VOUT will have a polarity opposite that of VIN. Thus

$$sgn ( \frac{VOUT}{VIN} ) = - 1 ,$$

where sgn(x) is the signum function and is defined as follows:

$$sgn ( x ) = \{ \begin{matrix}- 1 , & if x < 0 \\ 0 , & if x = 0 \\ 1 , & if x > 0\end{matrix}$$

The switching regulator includes an inductor L coupling an input node 410 to a switching node 420. A first capacitor C1 couples the switching node to a diode node 430. A first diode D1 couples the diode node to a common node 440. A second diode D2 couples the diode node to an output node 490. A second capacitor couples the output node 490 to the common node 440. A switch SW selectively couples the switching node to the common node. The first capacitor transfers energy from the input node 410 to the output node 490 in accordance with the commutation of the switch SW.

In one embodiment, the first diode is oriented to be forward-biased when switch SW is open to decouple the switching and common nodes. In contrast, the second diode is oriented to be forward-biased when switch SW is closed to couple the switching and common nodes.

This circuitry is similar to a Ćuk switching regulator in that a capacitor (C1) is the energy storage and transfer device between the input and output nodes. This circuitry may be distinguished from a Ćuk converter by the use of a second diode (D2) in lieu of a second inductor.

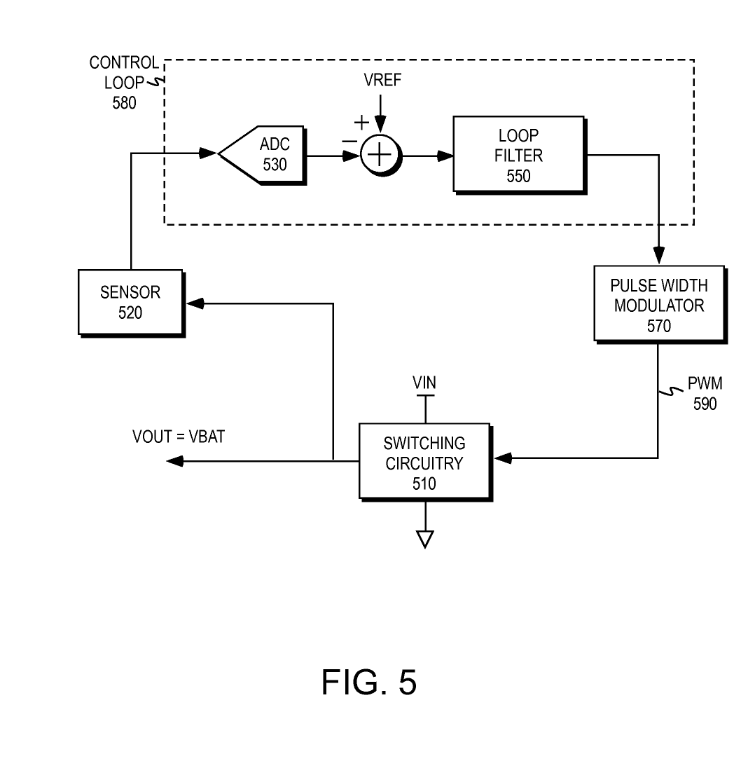

FIG. 5 illustrates one embodiment of a control loop for a DC-DC converter or switching regulator power supply. Switching regulator 510 is switched in accordance with the pulse width modulated control signals from PWM 570 to convert the DC VIN supply to the required DC VBAT supply. Sensor 520 is provided as part of the control loop for VBAT. The control loop may be effectuated in the analog domain or the digital domain.

The control loop in the illustrated embodiment is a digital control loop. However, the switching regulator control may be implemented as an analog control. In various embodiment, the signal processor of the SLIC is an integrated circuit and the components forming the control loop are fabricated as a portion of the integrated circuit signal processor.

Analog-to-digital converter (ADC) 530 samples and quantizes VBAT. Summer 540 compares the quantized VBAT with a digital value corresponding to a reference voltage (VREF) and generates an error signal. The error signal is processed by loop filter 550.

The transfer function of the loop filter 550 will be dependent upon the particular characteristics of the analog-to-digital converter 530. The loop filter generates the pulse control signal for the pulse width modulator (PWM 570). PWM 570 generates a pulse width modulated signal 590. PWM 570 generates pulses of varying width in accordance with the output of the loop filter. This PWM signal is then used to operate switching element 510. In one embodiment, the nominal frequency of the pulse width modulator is varied depending upon the operational state of the SLIC. Thus for example, one frequency may be utilized when the SLIC is in a ringing state while a different frequency is utilized for an off hook state.

During normal operation, the error signal forces the generation of PWM signals to cause the switching regulator to generate a voltage to reduce the error signal. However, during startup, short circuit conditions, and other overload events, the error signal can cause the switching regulator to generate excessive currents that stress the components of the switching regulator. Although more robust components (e.g., capacitors, diodes, switching transistors, etc.) can be used to decrease the possibility of component failure, such components add cost.

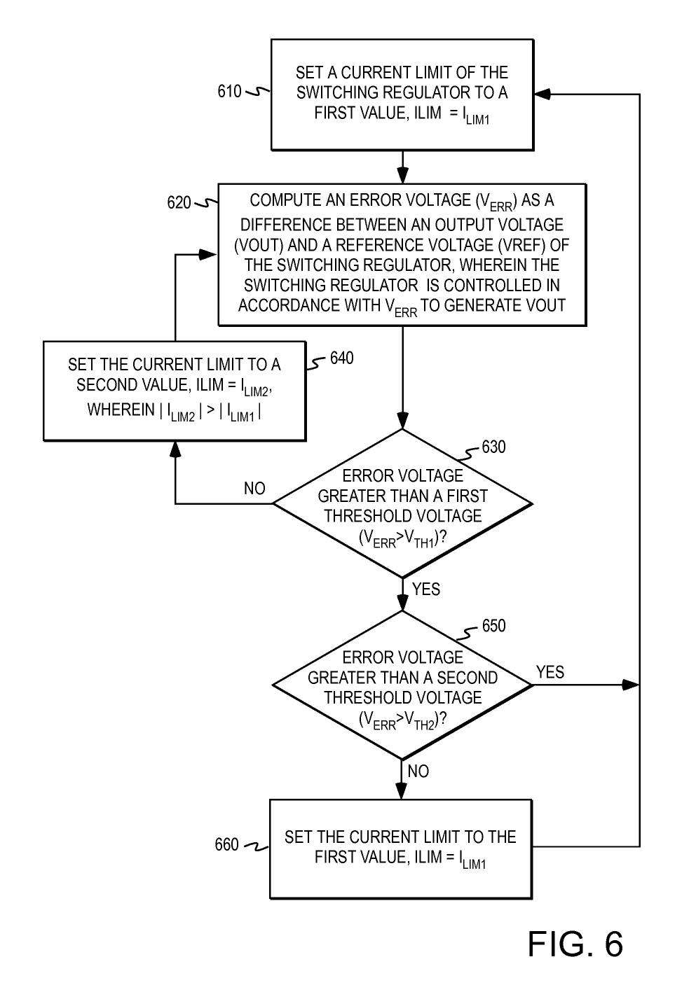

FIG. 6 illustrates one embodiment of a method of overcurrent protection for a switching regulator. During startup, VREF and various parameters are initialized. A switching regulator current limit is set to a first value, ILIM=I_{LIM1} in step 610.

An error voltage (V_{ERR}) is computed as a difference between the output voltage (VOUT) and a reference voltage VREF of the converter in step 620. If the error voltage does not exceed a first voltage threshold, (V_{TH1}) as determined by step 630, then the switching regulator current limit is set to a second value (ILIM=I_{LIM2}) in step 640. |I_{LIM2}|>|I_{LIM1}| such that the second value allows for a higher current. Thus I_{LIM1} is the low current limit and I_{LIM2} is the high current limit.

With respect to step 630, if V_{ERR}>V_{TH1}, then processing continues with step 650. In step 650, a determination is made whether the error voltage exceeds a second voltage threshold, V_{TH2}. In one embodiment, |V_{TH1}|>|V_{TH2}|. If V_{ERR} exceeds V_{TH2}, then processing continues with step 610. Otherwise, the switching regulator current limit is set to the first current limit (ILIM=I_{LIM1}) in step 660 before proceeding to step 610.

In one embodiment, the method of FIG. 6 is performed by a processor (such as SLIC signal processor 120 of FIG. 1) in accordance with executable instructions. In one embodiment, the executable instructions are stored in one of a nonvolatile or a volatile memory within the SLIC signal processor. I_{LIM1}, I_{LIM2}, V_{TH1}, V_{TH2} and other parameters may be represented as digital values in register or other memories within the signal processor.

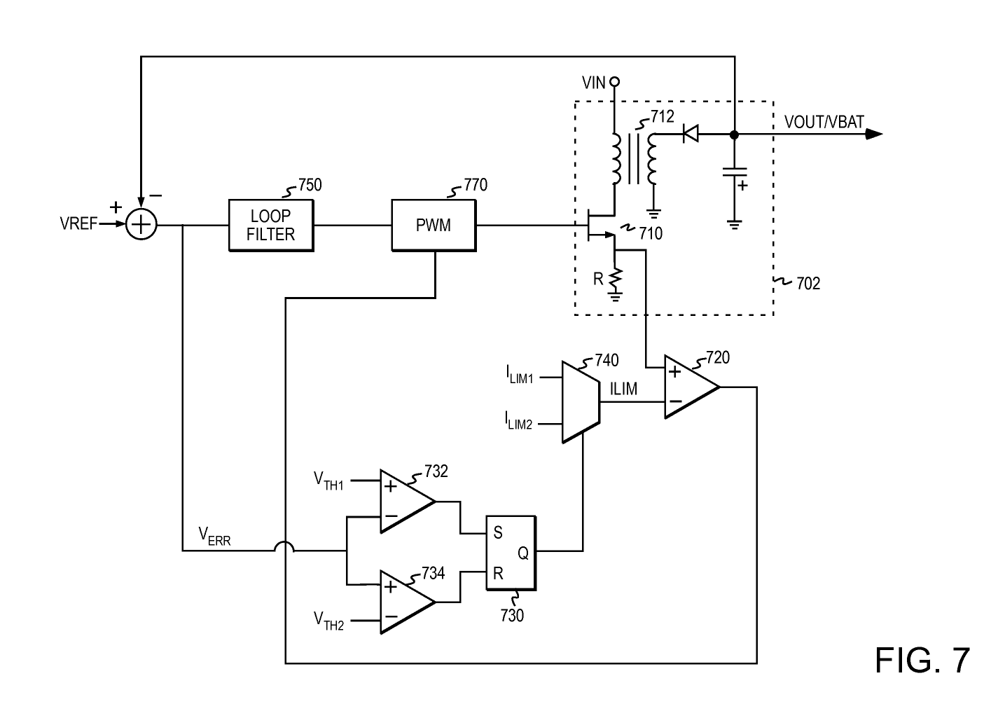

In an alternative embodiment, the overcurrent protection apparatus may be implemented as hardware. FIG. 7 illustrates one embodiment of a switching regulator overcurrent protection apparatus. The switching regulator 702 is an inverting switching regulator such that VOUT is of opposite polarity to VIN. Transformer 712 provides electrical isolation between the input and output of the switching regulator. The switching regulator control is illustrated as a digital control although the comparators are comparing analog values.

The switching regulator 702 includes switching element 710. In one embodiment, switching element 710 is an insulated gate field effect transistor. The switching regulator control relies upon a current mode control scheme. The voltage at resistor, R, is measured. This voltage is representative of the current passing through the primary winding (inductor) of transformer 712. Other switching regulator circuitry may be utilized as long as the control relies upon a current mode control scheme to sense a value indicative of inductor current.

The sensed voltage is compared with one of two limit current values, I_{LIM1}, I_{LIM2}, via comparator 740. These limit current values may be represented as voltages for comparison.

The comparator 740 output is provided as a control input to PWM 770. The output of PWM 770 is the switching signal provided to the switching transistor 710 of the switching regulator. When an overcurrent condition occurs as determined by the output of comparator 740, the PWM output is suppressed.

The error voltage is provided to comparators 732, 734. Comparator 732 drives the set input of S-R flip-flop 730. Comparator 734 drives the reset input of S-R flip-flop 730. Thus the set input will be “1” when V_{ERR}<V_{TH1} and “0” otherwise. The reset input will be “1” when V_{ERR}>V_{TH2} and “0” otherwise. The output of S-R flip flop is provided to multiplexer 740 for selecting which current limit threshold (I_{LIM1}, I_{LIM2}) is provided to comparator 720.

In one embodiment, any combinational or sequential logic (e.g., S-R flip flop 730), multiplexer 740, and comparators 720, 732, 734 for the switching regulator control loop are fabricated as a portion of an integrated circuit signal processor of a SLIC.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A method of controlling a switching regulator overcurrent protection, comprising:
a) setting a switching regulator current limit (ILIM) to a first value, I_{LIM1};
b) computing an error voltage (V_{ERR}) as a difference between an output voltage VOUT of the switching regulator and a reference voltage VREF of the switching regulator;
c) setting the switching regulator current limit to a second value (I_{LIM2}), if the error voltage is greater than a first threshold voltage (V_{TH1}); and
d) setting the switching regulator current limit to the first value, if the error voltage does not exceed a second threshold value, V_{TH2}.

2. The method of claim 1, wherein |V_{TH1}|>|V_{TH2}|.

3. The method of claim 1, wherein |I_{LIM1}|>|I_{LIM2}|.

4. The method of claim 1 wherein the switching regulator is an inverting switching regulator.

5. The method of claim 1 wherein the switching regulator provides electrical isolation between an input and the output of the switching regulator.

6. The method of claim 1 further comprising:
e) providing VOUT as VBAT for a subscriber line interface circuit.

7. The method of claim 1 wherein steps a)-d) are performed by a signal processor executing executable instructions.

8. The method of claim 7 wherein the signal processor is an integrated circuit.

9. The method of claim 8 wherein the executable instructions are stored in one of a nonvolatile and a volatile memory within the signal processor integrated circuit.

10. The method of claim 8 wherein I_{LIM1}, I_{LIM2}, V_{TH1}, and V_{TH2} are represented as digital values stored within the signal processor.
